(19) United States
(12) Patent Application Publication
(10) Pub. No.: US 2024/0425078 A1
(43) Pub. Date: Dec. 26, 2024

(54) DRIVER EVALUATION INFORMATION PROVIDING DEVICE AND EVALUATION INFORMATION PROVIDING METHOD

(71) Applicant: TOYOTA JIDOSHA KABUSHIKI KAISHA, Toyota-shi (JP)

(72) Inventor: Yoshitaka FUWAMOTO, Mishima-shi (JP)

(73) Assignee: TOYOTA JIDOSHA KABUSHIKI KAISHA, Toyota-shi (JP)

(21) Appl. No.: 18/664,702

(22) Filed: May 15, 2024

(30) Foreign Application Priority Data
Jun. 20, 2023 (JP) 2023-100641

(51) Int. Cl. B60W 60/00; B60W 50/14; G06V 20/59

(52) U.S. Cl. CPC B60W 60/0013; B60W 50/14; G06V 20/597; B60W 2420/403; B60W 2540/229

(57) ABSTRACT

A driver evaluation information providing device includes a driver monitoring unit configured to monitor a condition of a driver of a vehicle based on an image of the driver captured by a driver monitor camera of the vehicle, a driving involvement degree evaluation unit configured to evaluate a driving involvement degree of the driver based on a result of monitoring of the condition of the driver by the driver monitoring unit, and an information providing unit configured to provide, to the driver, information about the driving involvement degree evaluated by the driving involvement degree evaluation unit.

### CROSS-REFERENCE TO RELATED APPLICATION

This application claims priority to Japanese Patent Application No. 2023-100641 filed on Jun. 20, 2023, incorporated herein by reference in its entirety.

### BACKGROUND

### 1. Technical Field

The present disclosure relates to a driver evaluation information providing device and an evaluation information providing method.

### 2. Description of Related Art

WO 2020/188634 is known as a technical document relating to a driver evaluation information providing device. This publication discloses a driver monitoring device that outputs an alert depending on the condition of a driver of a vehicle.

### SUMMARY

When there is a large difference between the evaluation of the driver's condition by the device of the vehicle and the driver's evaluation of his or her condition, the driver may feel uncomfortable about the alert etc. given to the driver by the device.

A driver evaluation information providing device according to a first aspect of the present disclosure includes a driver monitoring unit configured to monitor a condition of a driver of a vehicle based on an image of the driver captured by a driver monitor camera of the vehicle, a driving involvement degree evaluation unit configured to evaluate a driving involvement degree of the driver based on a result of monitoring of the condition of the driver by the driver monitoring unit, and an information providing unit configured to provide, to the driver, information about the driving involvement degree evaluated by the driving involvement degree evaluation unit.

The driver evaluation information providing device according to the first aspect of the present disclosure can provide information to the driver of the vehicle about the driving involvement degree of the driver evaluated by the device. Therefore, it is possible to reduce the occurrence of a case where the driver feels uncomfortable even if an alert is output to the driver or autonomous driving or driving assist is terminated based on the driving involvement degrec.

In the driver evaluation information providing device according to the first aspect of the present disclosure, the information providing unit may be configured to, when the vehicle is performing traveling control as autonomous driving or driving assist, provide information indicating that the driving involvement degree is approaching a termination determination threshold to the driver. When the driving involvement degree is lower than the termination determination threshold, the traveling control may be terminated. The driver evaluation information providing device provides information to the driver to indicate that the driving involvement degree is approaching the termination determination threshold. Therefore, it is possible to reduce the occurrence of a case where the driver feels uncomfortable about the termination of the traveling control as the autonomous driving or the driving assist due to a decrease in the driving involvement degree of the driver evaluated by the device.

In the driver evaluation information providing device according to the first aspect of the present disclosure, the information providing unit may be configured to, when the vehicle is performing the traveling control, provide information indicating that the driving involvement degree is changing away from the termination determination threshold. The driver evaluation information providing device provides information to the driver to indicate that the driving involvement degree evaluated by the device is changing away from the termination determination threshold. Therefore, motivation to increase the driving involvement degree can be given to the driver who desires to continue the traveling control as the autonomous driving or the driving assist.

In the driver evaluation information providing device according to the first aspect of the present disclosure, the information providing unit may be configured to continuously provide, by changing a length of a bar-shaped lit portion of a display unit provided in front of a driver's seat of the vehicle, information about the driving involvement degree to the driver while the traveling control is being performed. While the traveling control is being performed, the driver evaluation information providing device causes the display unit to provide information to the driver continuously. Therefore, the driver can check the driving involvement degree evaluated by the device at any timing during the autonomous driving or the driving assist.

In the driver evaluation information providing device according to the first aspect of the present disclosure, the information providing unit may be configured to highlight an end of the bar-shaped lit portion of the display unit. The end may be configured to change, based on a change in the driving involvement degree, in length. The information providing unit may be configured to vary a first highlight and a second highlight. The first highlight may be a highlight of the end when the bar-shaped lit portion is configured to decrease in length due to a decrease in the driving involvement degree. The second highlight may be a highlight of the end when the bar-shaped lit portion is configured to increase in length due to an increase in the driving involvement degree. The driver evaluation information providing device highlights the end of the bar-shaped lit portion of the display unit that changes in length depending on a change in the driving involvement degrec. Therefore, the driver can easily notice the change in the driving involvement degree. Further, the driver evaluation information providing device varies the highlight of the end of the lit portion that decreases in length and the highlight of the end of the lit portion that increases in length. Therefore, the driver can easily know whether the driving involvement degree is decreasing or increasing.

A second aspect of the present disclosure relates to an evaluation information providing method for a driver evaluation information providing device configured to provide information to a driver of a vehicle. The evaluation information providing method includes monitoring, by the driver evaluation information providing device, a condition of the driver based on an image of the driver captured by a driver monitor camera of the vehicle, evaluating, by the driver evaluation information providing device, a driving involvement degree of the driver based on a result of monitoring of the condition of the driver, and providing, by the driver evaluation information providing device, information about the driving involvement degree to the driver.

With the evaluation information providing method for the driver evaluation information providing device according to the second aspect of the present disclosure, information can be provided to the driver of the vehicle about the driving involvement degree of the driver evaluated by the device. Therefore, it is possible to reduce the occurrence of a case where the driver feels uncomfortable even if an alert is output to the driver or autonomous driving or driving assist is terminated based on the driving involvement degree.

A third aspect of the present disclosure relates to a driver evaluation information providing device. The driver evaluation information providing device includes an electric control unit. The electric control unit is configured to monitor a condition of a driver of a vehicle based on an image of the driver captured by a driver monitor camera of the vehicle, evaluate a driving involvement degree of the driver based on a result of monitoring of the condition of the driver, and provide, to the driver, information about the driving involvement degree.

According to each aspect of the present disclosure, it is possible to reduce the occurrence of a case where the driver feels uncomfortable about the output etc. based on the driving involvement degree by providing information to the driver of the vehicle about the result of the evaluation of the driving involvement degree of the driver recognized by the device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a driver evaluation information providing device according to an embodiment;

FIG. 2 shows an example of a display unit provided in front of a driver's seat;

FIG. 3 is a graph showing an example of changes in information provision contents depending on a driving involvement degree;

FIG. 4 is a table showing an example of information provision contents and display modes of the display unit associated with the driving involvement degree;

FIG. 5 is a flowchart showing an example of an evaluation information providing method for the driver evaluation information providing device; and

FIG. 6 is a flowchart showing an example of a method for switching service levels as information provision targets.

### DETAILED DESCRIPTION OF EMBODIMENTS

An embodiment of the present disclosure will be described below with reference to the drawings.

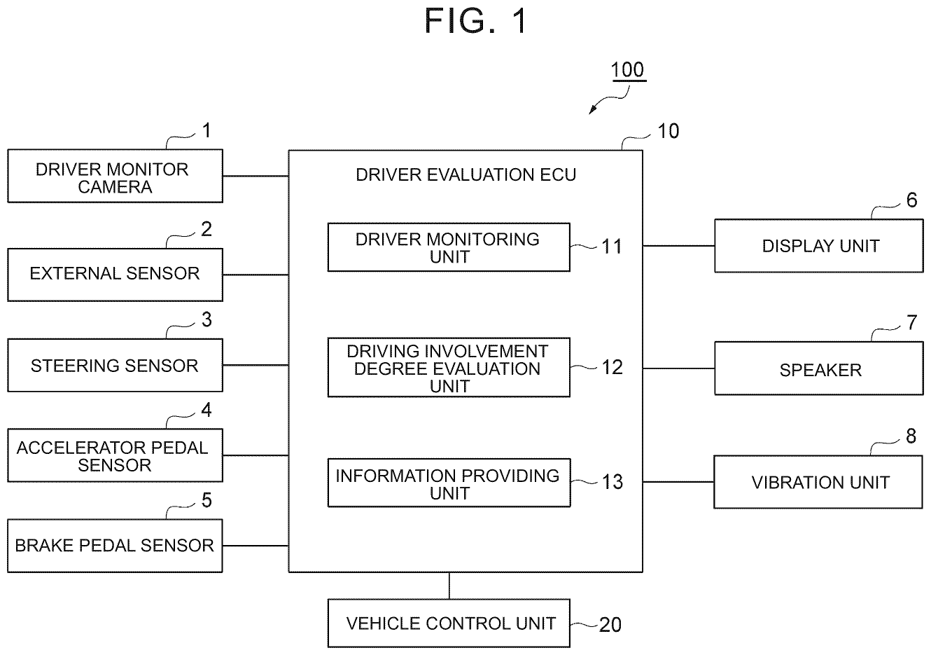

FIG. 1 is a block diagram showing a driver evaluation information providing device 100 according to an embodiment. The driver evaluation information providing device 100 shown in FIG. 1 is mounted on a vehicle, and provides a driver of the vehicle with information on a driving involvement degree evaluated by the device. The driving involvement degree is a degree of involvement or concentration of the driver in driving.

The vehicle is, for example, a vehicle that can perform autonomous driving or driving assist. The autonomous driving is traveling control for causing a vehicle to travel autonomously without driving operations of a driver. In the traveling control as the autonomous driving, both the vehicle speed and the steering of the vehicle are controlled without driving operations of the driver. The autonomous driving corresponds to, for example, control at autonomous driving level 3 or higher certified by the Society of Automotive Engineers (SAE).

The driving assist is vehicle control for assisting driving operations of a driver so that the vehicle travels appropriately. The driving assist according to the present embodiment includes vehicle traveling control such as adaptive cruise control (ACC), lane keeping assist (LKA), and parking assist. In the traveling control as the driving assist, at least one of the vehicle speed and the steering of the vehicle is controlled while the driver is not inputting driving operations. The driving assist corresponds to, for example, autonomous driving level 1 or 2 certified by the Society of Automotive Engineers (SAE). The vehicle need not necessarily perform the autonomous driving or the driving assist.

### Configuration of Driver Evaluation Information Providing Device

The configuration of the driver evaluation information providing device 100 according to the present embodiment will be described below. As shown in FIG. 1, the driver evaluation information providing device 100 includes a driver evaluation electronic control unit (ECU) 10 that centrally manages the device.

The driver evaluation ECU 10 is an electronic control unit including a central processing unit (CPU) and a storage unit such as a read only memory (ROM) or a random access memory (RAM). For example, the driver evaluation ECU 10 implements various functions by the CPU executing programs stored in the storage unit. The driver evaluation ECU 10 may be constituted by a plurality of electronic units.

The driver evaluation ECU 10 is connected to a driver monitor camera 1, an external sensor 2, a steering sensor 3, an accelerator pedal sensor 4, a brake pedal sensor 5, a display unit 6, a speaker 7, a vibration unit 8, and a vehicle control unit 20.

The driver monitor camera 1 is a camera that captures an image of the driver. The driver monitor camera 1 is provided, for example, on a cover of a steering column of the vehicle at a position in front of the driver's seat. A plurality of driver monitor cameras 1 may be provided in order to capture images of the driver in a plurality of directions. The driver monitor camera 1 transmits the captured image of the driver to the driver evaluation ECU 10.

The external sensor 2 is a detection device that detects the surrounding environment of the vehicle. The external sensor 2 includes an external camera and a radar sensor. For example, the external camera includes a front camera that is provided on a back side of a windshield of the vehicle and captures an image of an area ahead of the vehicle. The external camera may include cameras provided at the rear and sides of the vehicle. The external camera transmits imaging information on the outside of the vehicle to the driver evaluation ECU 10.

The radar sensor is a detection device that detects an object around the vehicle by using radio waves (e.g., millimeter waves) or light. Examples of the radar sensor include a millimeter-wave radar and a light detection and ranging (LIDAR) sensor. The radar sensor detects an obstacle by transmitting radio waves or light to the surroundings of the vehicle and receiving the radio waves or light reflected by an object. The radar sensor transmits information on the detected object to the driver evaluation ECU 10.

The steering sensor 3 is a sensor that detects grip of a steering wheel of the vehicle by the driver. The steering sensor 3 may include a pressure-sensitive sensor provided on the steering wheel or a touch sensor that detects a current in a human body. The steering sensor 3 may detect an operation on the steering wheel by the driver. The steering sensor 3 transmits a result of detection of the grip of the steering wheel by the driver, etc. to the driver evaluation ECU 10. The steering wheel is not limited to a wheel-shaped device, but may be any device that functions as a handgrip.

The accelerator pedal sensor 4 detects depression of an accelerator pedal of the vehicle by the driver. The accelerator pedal sensor 4 is configured to detect a state in which the driver's foot is placed on the accelerator pedal. The accelerator pedal sensor 4 transmits a result of detection of the depression of the accelerator pedal of the vehicle by the driver, etc. to the driver evaluation ECU 10.

The brake pedal sensor 5 detects depression of a brake pedal by the driver. The brake pedal sensor 5 is configured to detect a state in which the driver's foot is placed on the brake pedal. The brake pedal sensor 5 transmits a result of detection of the depression of the brake pedal of the vehicle by the driver, etc. to the driver evaluation ECU 10.

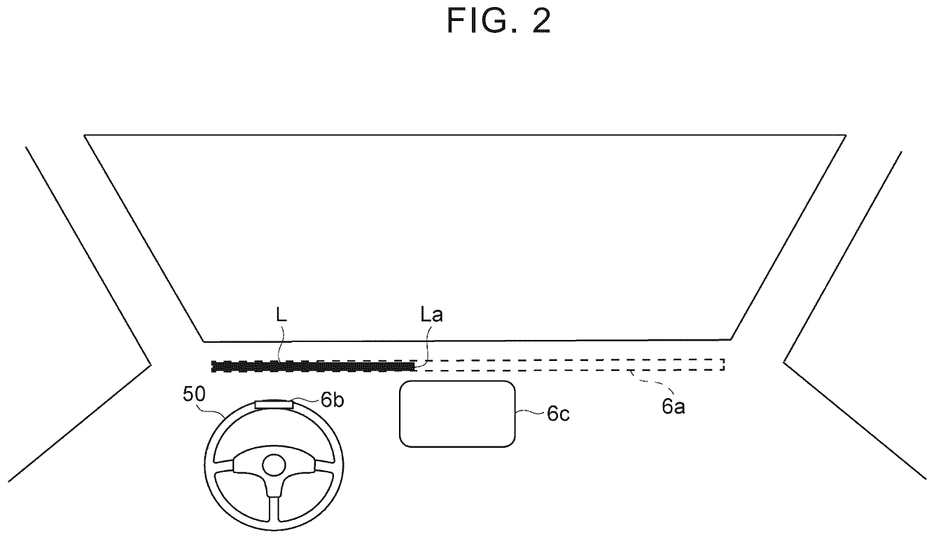

The display unit 6 is a device to be used to provide visual information to the driver. The display unit 6 is provided, for example, in front of the driver's seat. FIG. 2 shows an example of the display unit provided in front of the driver's seat. FIG. 2 shows a first display unit 6a, a second display unit 6b, and a center display 6c. As shown in FIG. 2, the display unit 6 includes, for example, the first display unit 6a, the second display unit 6b, and the center display 6c.

The first display unit 6a is a bar-shaped light source provided on an instrument panel of the vehicle to extend to the right and left of the vehicle. The first display unit 6a is provided at a position where the first display unit 6a comes into the driver's sight while the driver is viewing an area ahead of the vehicle. The first display unit 6a can be constituted by, for example, light emitting diodes (LEDs). The first display unit 6a is provided, for example, from a position in front of the driver's seat to a position in front of a passenger's seat.

For example, the first display unit 6a provides information on the driving involvement degree to the driver based on the length of a bar-shaped lit portion L. An end of the lit portion L that changes in length depending on a change in the driving involvement degree is represented by a symbol La. The length of the first display unit 6a is not particularly limited, and may be a length from the position in front of the driver's seat to the center of the vehicle, or may be shorter than this length.

The second display unit 6b is a light source provided on an upper part of a steering wheel 50 of the vehicle. The second display unit 6b can be, for example, a steering illumination constituted by LEDs. The second display unit 6b can be a rectangular light source extending to the right and left of the vehicle. The shape of the second display unit 6b is not particularly limited. The shape of the second display unit 6b may be a square, a rhombus, or an ellipse. The second display unit 6b may be provided not on the upper part of the steering wheel 50 but on the cover of the steering column.

The center display 6c is a display provided at the center of the instrument panel of the vehicle. The center display 6c is used, for example, for route guidance by a navigation system of the vehicle. The center display 6c need not necessarily be positioned at the center of the instrument panel. The center display 6c need not necessarily be usable as the display of the navigation system.

The display unit 6 need not necessarily include all of the first display unit 6a, the second display unit 6b, and the center display 6c, and may include only one of them. The display unit 6 may include any other device that provides visual information to the driver without including any of the first display unit 6a, the second display unit 6b, and the center display 6c. The display unit 6 may include, for example, a head-up display (HUD) that projects image information onto the windshield of the vehicle or a multi-information display (MID) of meters. The display unit 6 only needs to include at least one of the display devices described above.

The speaker 7 is a device to be used to provide audio information to the driver. The speaker 7 is configured to output sound and voice to the driver in a vehicle cabin.

The vibration unit 8 is a device to be used to provide vibrational information to the driver. The vibrational information is provided in combination with the visual or audio information. The vibration unit 8 includes, for example, a steering actuator that vibrates the steering wheel of the vehicle.

The vibration unit 8 may include a belt actuator that takes up a seat belt at the driver's seat of the vehicle. The vibration unit 8 may provide information to the driver by lightly pulling the driver's seat belt. The vibration unit 8 may include a seat actuator that vibrates an armrest or seat at the driver's seat.

The vehicle control unit 20 controls the traveling of the vehicle by transmitting control signals to drive units (engine actuator, brake actuator, steering actuator, etc.) of the vehicle. The vehicle control unit 20 performs autonomous driving or driving assist of the vehicle that is permitted by the driver. Detailed description of the autonomous driving and the driving assist will be omitted. When the vehicle control unit 20 receives a traveling control termination signal from the driver evaluation ECU 10 during the autonomous driving or the driving assist of the vehicle, the vehicle control unit 20 terminates the traveling control that is being performed (traveling control as autonomous driving or driving assist).

When the vehicle control unit 20 receives the traveling control termination signal from the driver evaluation ECU 10 during the autonomous driving of the vehicle and terminates the traveling control of the autonomous driving, the vehicle control unit 20 may shift to the traveling control of the driving assist. That is, the vehicle control unit 20 may shift from autonomous driving level 3 or higher to autonomous driving level 2 when the traveling control termination signal is received from the driver evaluation ECU 10.

Next, the functional configuration of the driver evaluation ECU 10 will be described. As shown in FIG. 1, the driver evaluation ECU 10 includes a driver monitoring unit 11, a driving involvement degree evaluation unit 12, and an information providing unit 13. An electric control unit is an example of the driver evaluation ECU 10.

The driver monitoring unit 11 monitors the condition of the driver of the vehicle based on an image of the driver captured by the driver monitor camera 1 of the vehicle. The driver monitoring unit 11 recognizes, for example, the orientation of the driver's face. When the driver is paying attention to the driving or traveling of the vehicle, the driver's face is considered to be oriented forward from the vehicle. The driver monitoring unit 11 recognizes the orientation of the driver's face by a known image processing technology.

The driver monitoring unit 11 may recognize the orientation of the driver's face by using a machine learning model. The machine learning model receives, for example, an image of the driver captured by the driver monitor camera 1 as input, and outputs a result of recognition of the orientation of the face. The machine learning model is a neural network such as a convolutional neural network (CNN). The neural network can include a plurality of layers including a plurality of convolutional layers and pooling layers. A deep learning network based on deep learning may be used as the neural network. Machine learning models that appear hereinafter in the present embodiment can also have similar neural network structures.

The driver monitoring unit 11 may monitor the driver's eye condition. The driver's eye condition includes the driver's line of sight. The driver's eye condition may include at least one of, for example, eyeball saccades, a blink frequency, an eye closing speed, and an eye closing state (upper eyelid position). The driver monitoring unit 11 recognizes the driver's eye condition including the line of sight by using an image processing technology or a machine learning model.

The driver monitoring unit 11 may recognize that the driver is in a look-away state or a distracted state based on the orientation of the driver's face or the driver's eye condition. The look-away state is a state in which the driver is viewing scenery outside the vehicle that is unrelated to the driving of the vehicle. The distracted state is a state in which the driver is viewing the inside of the vehicle that is unrelated to the driving of the vehicle. The distracted state includes a state in which the driver is facing another passenger and having a conversation, a state in which the driver is operating the navigation system or other devices of the vehicle, and a state in which the driver is operating a smartphone etc.

The driver monitoring unit 11 may recognize that the driver is in an unconcentrated state based on the orientation of the driver's face or the driver's eye condition. The unconcentrated state includes a state in which the driver is unable to concentrate on driving due to lack of sleep, and a state in which the driver is unable to concentrate on driving due to thinking. The driver monitoring unit 11 recognizes that the driver is in the unconcentrated state based on, for example, eyeball saccades, a blink frequency, an eye closing speed, and an eye closing state (upper eyelid position).

The driver monitoring unit 11 may monitor the condition of the driver based on a detection result from the steering sensor 3. When the driver is paying attention to the driving or traveling of the vehicle, the driver is considered to be gripping the steering wheel. The driver monitoring unit 11 recognizes that the driver is gripping the steering wheel based on the detection result from the steering sensor 3. The driver monitoring unit 11 may distinctively recognize whether the driver is gripping the steering wheel with both hands or with one hand. The driver monitoring unit 11 may recognize the amount of steering of the steering wheel by the driver.

The driver monitoring unit 11 may monitor the condition of the driver based on a detection result from the accelerator pedal sensor 4 or the brake pedal sensor 5. When the driver's foot is placed on the accelerator or brake pedal, it can be considered that the driver has a strong possibility of paying attention to the driving or traveling of the vehicle.

The driver monitoring unit 11 recognizes that the driver's foot is placed on the accelerator or brake pedal based on the detection result from the accelerator pedal sensor 4 or the brake pedal sensor 5. When the driver is depressing the accelerator or brake pedal, the driver monitoring unit 11 may recognize the amount of pedal depression by the driver.

The driving involvement degree evaluation unit 12 evaluates the driving involvement degree of the driver based on a result of monitoring of the condition of the driver by the driver monitoring unit 11. For example, the driving involvement degree evaluation unit 12 evaluates the driving involvement degree lower in a case where the driver is in the look-away state than in a case where the driver is facing forward from the vehicle. When the driver's line of sight is directed toward a side mirror, the driving involvement degree is not evaluated low.

The driving involvement degree evaluation unit 12 may evaluate the driving involvement degree lower in a case where the driver is in the distracted state than in a case where the driver is facing forward from the vehicle. When the driver's line of sight is directed toward a rearview mirror, the driving involvement degree is not evaluated low. In a case where the driver is in the distracted state and is operating an information device installed in the vehicle for vehicle navigation, music playback, phone call, etc., the driving involvement degree evaluation unit 12 may evaluate the driving involvement degree lower than in a case where the driver is not operating the information device. The driving involvement degree evaluation unit 12 acquires a signal related to the driver's operation from the information device installed in the vehicle.

The driving involvement degree evaluation unit 12 may evaluate the driving involvement degree lower in a case where the driver is in the unconcentrated state than in a case where the driver is not in the unconcentrated state. The driving involvement degree evaluation unit 12 may evaluate the lack of driver's concentration in stages. The driving involvement degree evaluation unit 12 may evaluate the driving involvement degree lower in a case where the driver lacks concentration due to lack of sleep than in a case where the driver lacks concentration for other reasons. The driving involvement degree evaluation unit 12 may evaluate the driving involvement degree lower as the duration of the look-away state, the distracted state, or the unconcentrated state of the driver increases.

In a case where the frequency of the driver's surrounding monitoring action is lower than a predetermined value, the driving involvement degree evaluation unit 12 may evaluate the driving involvement degree lower than in a case where the frequency of the driver's surrounding monitoring action is equal to or higher than the predetermined value. The surrounding monitoring action can include actions of checking not only an arca ahead of the vehicle but also the side mirrors, the rearview mirror, an adjacent lane, an adjacent sidewalk, and traffic lights ahead of the vehicle.

The driving involvement degree evaluation unit 12 may evaluate the driving involvement degree of the driver based on a traveling environment outside the vehicle that is detected by the external sensor 2. The driving involvement degree evaluation unit 12 determines whether the driver is facing in an extending direction of a traveling lane of the vehicle that is detected by the external sensor 2 based on the extending direction of the traveling lane and the orientation of the driver's face recognized by the driver monitoring unit 11. When the driver is paying attention to the driving or traveling of the vehicle, the orientation of the driver's face is considered to change depending on a direction of a curve, for example, in a case where the traveling lane is a curve. The driving involvement degree evaluation unit 12 may evaluate the driving involvement degree lower in a case where the driver is not facing in the extending direction of the traveling lane than in a case where the driver is facing in the extending direction of the traveling lane.

The driving involvement degree evaluation unit 12 may evaluate the driving involvement degree lower along with an increase in the number of viewing targets that have never been viewed by the driver among the viewing targets detected by the external sensor 2, such as traffic lights, road signs, preceding vehicles, overtaking vehicles, and pedestrians ahead of the vehicle. In a case where the number of times the driver views a viewing target in a predetermined period (the number of times any viewing target is viewed) is smaller than a predetermined value, the driving involvement degree evaluation unit 12 may evaluate the driving involvement degree lower than in a case where the number of times the driver views the viewing target is equal to or larger than the predetermined value.

The driving involvement degree evaluation unit 12 may evaluate the driving involvement degree of the driver based on acceleration or deceleration of the vehicle and the driver's head condition. When the driver is paying attention to the driving or traveling of the vehicle, the driver predicts the traveling situation of the vehicle (starting, accelerating, decelerating, or stopping) and prepares for changes in longitudinal acceleration. Therefore, the shaking of the driver's head is considered to decrease compared to drivers who are not paying attention to the driving. The driving involvement degree evaluation unit 12 may evaluate the driving involvement degree lower as the shaking of the driver's head increases during acceleration or deceleration of the vehicle.

The driving involvement degree evaluation unit 12 may evaluate the driving involvement degree lower in a case where the driver is not gripping the steering wheel than in a case where the driver is gripping the steering wheel. When the driver is not gripping the steering wheel, the driving involvement degree evaluation unit 12 may evaluate the driving involvement degree lower along with an increase in a period that has elapsed since the driver gripped the steering wheel last time. The driving involvement degree evaluation unit 12 may evaluate the driving involvement degree lower in a case where the driver is gripping the steering wheel with one hand than in a case where the driver is gripping the steering wheel with both hands.

The driving involvement degree evaluation unit 12 may evaluate the driving involvement degree lower in a case where the driver's foot is not placed on the accelerator or brake pedal than in a case where the driver's foot is placed on the accelerator or brake pedal. When the driver's foot is not placed on the accelerator or brake pedal, the driving involvement degree evaluation unit 12 may evaluate the driving involvement degree lower along with an increase in a period that has elapsed since the driver's foot was placed on the accelerator or brake pedal last time.

In a case where the number of times the driver overrides the traveling in the autonomous driving or the driving assist of the vehicle in a predetermined period by steering the steering wheel, depressing the accelerator pedal, or depressing the brake pedal is smaller than a predetermined value, the driving involvement degree evaluation unit 12 may evaluate the driving involvement degree lower than in a case where the number of times the driver overrides the traveling in the predetermined period is equal to or larger than the predetermined value.

The driving involvement degree evaluation unit 12 may change the driving involvement degree evaluation method depending on whether the vehicle is performing the autonomous driving or the driving assist. For example, the driving involvement degree evaluation unit 12 may reduce the amount of decrease in the evaluation of the driving involvement degree due to the look-away state, the distracted state, or the unconcentrated state of the driver in a case where the autonomous driving is being performed compared to a case where the driving assist is being performed. For example, the driving involvement degree evaluation unit 12 may reduce the amount of decrease in the evaluation of the driving involvement degree due to the state in which the driver is not gripping the steering wheel in a case where the autonomous driving is being performed compared to a case where the driving assist is being performed. For example, the driving involvement degree evaluation unit 12 may reduce the amount of decrease in the evaluation of the driving involvement degree due to the state in which the driver's foot is not placed on the accelerator or brake pedal in a case where the autonomous driving is being performed compared to a case where the driving assist is being performed.

The information providing unit 13 provides information to the driver about the driving involvement degree of the driver evaluated by the driving involvement degree evaluation unit 12. The information providing unit 13 provides information to the driver by using, for example, the display unit 6. The information provided to the driver by the information providing unit 13 is not limited to visual information but may be sound and voice information or information provided by vibration of the steering wheel or by other methods.

The information providing unit 13 provides information on the driving involvement degree to the driver by, for example, shortening the bar-shaped lit portion of the first display unit 6a of the display unit 6 as the driving involvement degree decreases (see FIG. 2). The information providing unit 13 may change the length of the lit portion that extends toward the passenger's seat from the end of the first display unit 6a on the driver's seat side, or may change the length of the lit portion that extends to the right and left from the center position of the first display unit 6a.

The information providing unit 13 may highlight the end of the lit portion where the length changes (e.g., the end La in FIG. 2). When the lit portion extends or contracts to the right and left, both ends are highlighted. The information providing unit 13 may increase the brightness of the end or change the color of the end as the highlight. The color of the end may be changed to a darker or lighter color than the color of the other part, or may be changed to a different color. As the highlight, the information providing unit 13 may shorten the lighting period of the end compared to the other part or add an animation effect such as fading. In a case of displaying the bar-shaped lit portion on an HUD, various animation effects can be employed as typified by displaying of a plurality of star-shaped images around the end.

The information providing unit 13 may vary the highlight of the end of the lit portion that decreases in length due to a decrease in the driving involvement degree and the highlight of the end of the lit portion that increases in length due to an increase in the driving involvement degree. For example, the information providing unit 13 changes the color of the end as the highlight depending on whether the length of the lit portion decreases or increases. The information providing unit 13 may change the blinking period or the animation effect of the end as the highlight. The information providing unit 13 may change the blinking period of the end to a shorter period as the rate of change in the length of the lit portion (rate of increase or decrease in the driving involvement degree) increases, or may change the color of the end to a darker color as the rate of change in the length of the lit portion increases.

The information providing unit 13 may provide information on the driving involvement degree to the driver by, for example, shortening the blinking period of the light source of the second display unit 6b of the display unit 6 on the steering wheel 50 as the driving involvement degree decreases. The information providing unit 13 may provide information on the driving involvement degree to the driver by, for example, displaying numerical values and texts associated with the driving involvement degree on the center display 6c of the display unit 6. The information providing unit 13 may use an HUD or an MID instead of the first display unit 6a, the second display unit 6b, and the center display 6c.

The information providing unit 13 provides information on the driving involvement degree continuously in real time when the driver has turned ON the driving involvement degree information providing function. The information providing unit 13 need not necessarily provide information continuously, and may provide information with predetermined time intervals. The predetermined time interval is not particularly limited. The predetermined time interval may be 1 second, 5 seconds, or 10 seconds.

When the traveling control is being performed as the autonomous driving or the driving assist in the vehicle, the information providing unit 13 may determine whether the driving involvement degree is lower than a termination determination threshold. The termination determination threshold is a threshold for terminating the traveling control of the autonomous driving or the driving assist. The termination determination threshold for the autonomous driving and the termination determination threshold for the driving assist can be different values. The termination determination threshold for the autonomous driving may be larger than the termination determination threshold for the driving assist.

When the information providing unit 13 determines that the driving involvement degree is lower than the termination determination threshold, the information providing unit 13 requests the driver to start manual driving and transmits a traveling control termination signal to the vehicle control unit 20. The vehicle control unit 20 that has received the traveling control termination signal terminates the traveling control as the autonomous driving or the driving assist. The request to start manual driving when the vehicle is performing the autonomous driving corresponds to a so-called hands-on request.

When the traveling control is being performed as the autonomous driving or the driving assist in the vehicle, the information providing unit 13 may provide information to the driver about a relationship between the driving involvement degree and the termination determination threshold. When the driving involvement degree is decreasing, the information providing unit 13 provides information to the driver to indicate that the driving involvement degree is approaching the termination determination threshold. When the driving involvement degree is increasing, the information providing unit 13 provides information to the driver to indicate that the driving involvement degree is changing away from the termination determination threshold. The information providing unit 13 may provide information to the driver about the relationship between the driving involvement degree and the termination determination threshold as a period remaining until the traveling control is terminated.

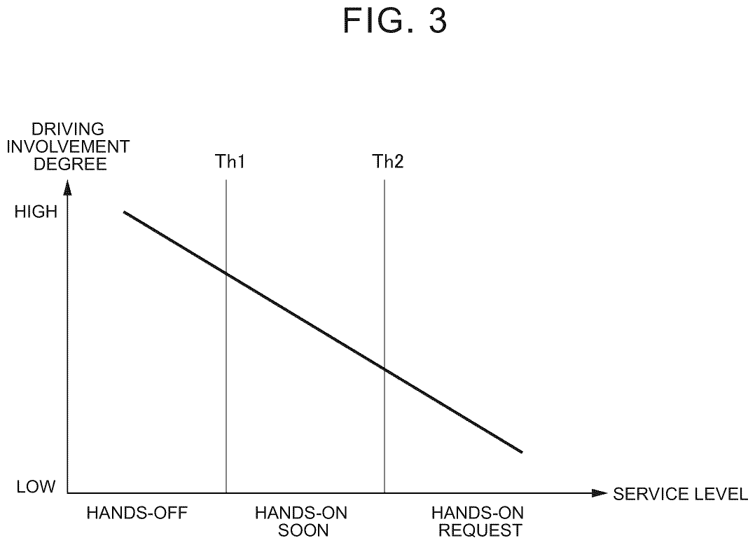

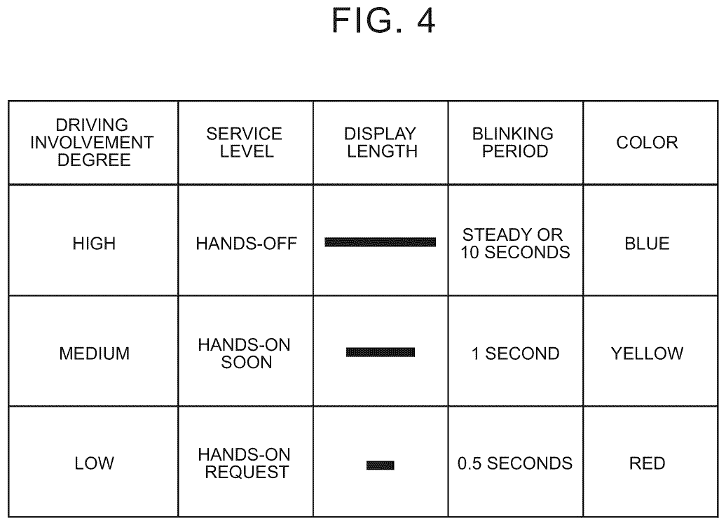

Specifically, the information providing unit 13 can provide information to the driver in a manner shown in FIGS. 3 and 4. The description will be given on the premise that the vehicle is performing the autonomous driving. FIG. 3 is a graph showing an example of changes in information provision contents depending on the driving involvement degree.

In FIG. 3, the vertical axis corresponds to the driving involvement degree, and the horizontal axis corresponds to a service level. “Hands-off” represents a level at which the driver is permitted to release the grip of the steering wheel. “Hands-on soon” represents a level at which a hands-on request will be given to the driver soon due to a decrease in the driving involvement degree. “Hands-on request” represents a level at which the driver is requested to prepare for manual driving. FIG. 3 shows a termination notice threshold Th1 and a termination determination threshold Th2. The termination notice threshold Th1 is a threshold to be used to give notice to the driver that the end of the autonomous driving is approaching.

FIG. 4 is a table showing an example of information provision contents and display modes of the display unit associated with the driving involvement degree. The “high” driving involvement degree in FIG. 4 corresponds to the case where the driving involvement degree in FIG. 3 is equal to or higher than the termination notice threshold Th1. The “medium” driving involvement degree corresponds to the case where the driving involvement degree in FIG. 3 is lower than the termination notice threshold Th1 and equal to or higher than the termination determination threshold Th2. The “low” driving involvement degree corresponds to the case where the driving involvement degree in FIG. 3 is lower than the termination determination threshold Th2.

As shown in FIGS. 3 and 4, when the driving involvement degree is “high”, the information providing unit 13 provides “hands-off” information to the driver. For example, the information providing unit 13 displays the longest bar-shaped lit portion on the first display unit 6a. The length of the bar-shaped lit portion may be changed continuously instead of in stages. The information providing unit 13 sets the blinking period of the first display unit 6a to “steady” (no blinking) or 10 seconds. The information providing unit 13 sets the color of the lit portion of the first display unit 6a to blue.

When the driving involvement degree is “medium”, the information providing unit 13 provides “hands-on soon” information to the driver. The information providing unit 13 displays the bar-shaped lit portion with a medium length on the first display unit 6a. The information providing unit 13 sets the blinking period of the first display unit 6a to 1 second. The information providing unit 13 sets the color of the lit portion of the first display unit 6a to yellow. The information providing unit 13 may provide information (alert to expected termination of autonomous driving) to the driver by using audio output from the speaker 7 and vibration of the steering wheel etc. by the vibration unit 8 in addition to the display unit 6.

When the driving involvement degree is “low”, the information providing unit 13 provides “hands-on request” information to the driver. The information providing unit 13 displays the shortest bar-shaped lit portion on the first display unit 6a. The information providing unit 13 sets the blinking period of the first display unit 6a to 0.5 seconds. The information providing unit 13 sets the color of the lit portion of the first display unit 6a to red. The lighting modes shown in FIG. 4 may be employed in the second display unit 6b or other display devices. The information providing unit 13 may provide information to the driver by using audio output from the speaker 7 and vibration of the steering wheel etc. by the vibration unit 8 in addition to the display unit 6.

In the case of “hands-on request”, the termination signal for the autonomous driving (traveling control) has already been transmitted to the vehicle control unit 20. Therefore, the autonomous driving is terminated even if the driver attempts to increase the driving involvement degree. When continuously changing the length of the bar-shaped lit portion, the information providing unit 13 may match the timing at which the length of the lit portion reaches zero with the timing at which the autonomous driving is terminated. In this case, the shortness of the lit portion corresponds to the period remaining until the autonomous driving is terminated.

The information providing unit 13 may provide information for the driving assist when switching is made to the driving assist due to the termination of the autonomous driving (autonomous driving level 3 shifts to autonomous driving level 2). When the driving involvement degree of the driver continues to decrease even after the switching to the driving assist and the driving involvement degree is lower than the termination notice threshold for the driving assist, the information providing unit 13 provides information to the driver about notice of termination of the driving assist. When the driving involvement degree is lower than the termination determination threshold Th2 for the driving assist, the information providing unit 13 transmits a termination signal for the driving assist (traveling control) to the vehicle control unit 20 and provides information on a request for manual driving due to the termination of the driving assist.

When the switching is made from the autonomous driving to the driving assist, the information providing unit 13 may restore the longest bar-shaped lit portion. When the switching is made to the driving assist, the information providing unit 13 may change the color of the lit portion compared to the case of autonomous driving. In the driving assist, the information providing unit 13 may set the color of the lit portion to green when the driving involvement degree is “high”, orange when the driving involvement degree is “medium”, and pink when the driving involvement degree is “low”.

### Evaluation Information Providing Method for Driver Evaluation Information Providing Device

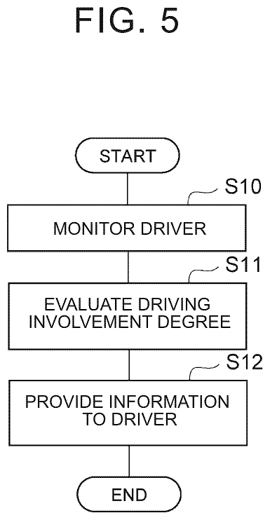

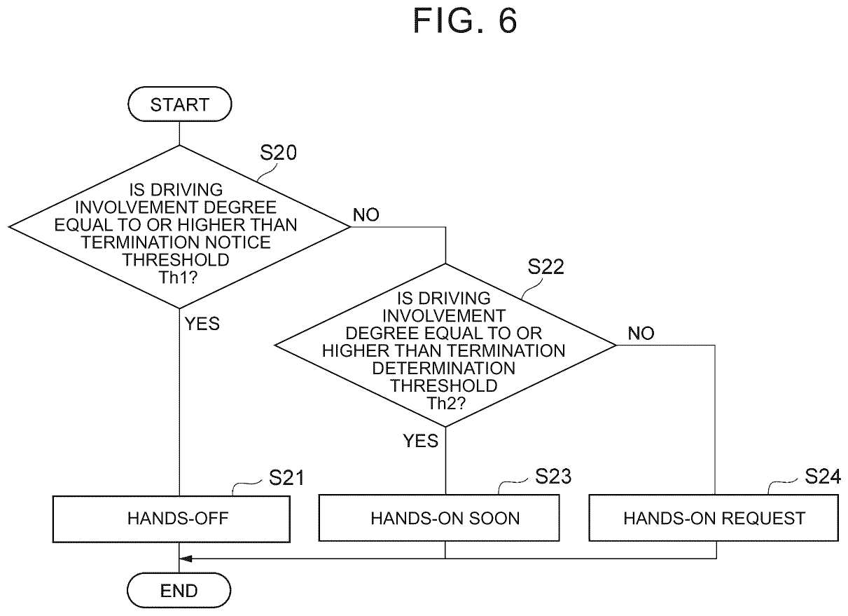

Next, an evaluation information providing method for the driver evaluation information providing device 100 in the present embodiment will be described with reference to FIGS. 5 and 6. FIG. 5 is a flowchart showing an example of the evaluation information providing method for the driver evaluation information providing device. The driver evaluation information providing device 100 performs the evaluation information providing method when the driver has turned ON the driving involvement degree information providing function. The driver evaluation information providing device 100 may perform the evaluation information providing method at the start of the autonomous driving or the driving assist.

As shown in FIG. 5, the driver evaluation ECU 10 of the driver evaluation information providing device 100 causes the driver monitoring unit 11 to monitor the condition of the driver of the vehicle in S10. The driver monitoring unit 11 monitors the condition such as the orientation of the driver's face based on an image of the driver of the vehicle captured by the driver monitor camera 1 of the vehicle.

In S11, the driver evaluation ECU 10 causes the driving involvement degree evaluation unit 12 to evaluate the driving involvement degree of the driver. The driving involvement degree evaluation unit 12 evaluates the driving involvement degree of the driver based on a result of monitoring of the condition of the driver by the driver monitoring unit 11.

In S12, the driver evaluation ECU 10 causes the information providing unit 13 to provide information to the driver. The information providing unit 13 provides information on the driving involvement degree of the driver evaluated by the driving involvement degree evaluation unit 12. The information providing unit 13 provides information by using the first display unit 6a of the display unit 6, etc. For example, the information providing unit 13 may also output sound or voice from the speaker 7 or vibrate the steering wheel by the vibration unit 8. Then, the driver evaluation ECU 10 returns to S10 and repeats the process.

FIG. 6 is a flowchart showing an example of a method for switching service levels as information provision targets. The method for switching service levels in FIG. 6 is performed, for example, as part of the information providing process of S12 shown in FIG. 5. The method for switching service levels will be exemplified on the premise that the vehicle is performing the autonomous driving.

As shown in FIG. 6, the driver evaluation ECU 10 of the driver evaluation information providing device 100 causes, in S20, the information providing unit 13 to determine whether the driving involvement degree is equal to or higher than the termination notice threshold Th1. When determination is made that the driving involvement degree is equal to or higher than the termination notice threshold Th1 (S20: YES), the driver evaluation ECU 10 proceeds to S21. When determination is not made that the driving involvement degree is equal to or higher than the termination notice threshold Th1 (S20: NO), the driver evaluation ECU 10 proceeds to S22.

In S21, the driver evaluation ECU 10 causes the information providing unit 13 to provide the driver with information associated with the service level “hands-off”. The information providing unit 13 causes the display unit 6 to provide the information on the service level “hands-off” related to the driving involvement degree.

In S22, the driver evaluation ECU 10 causes the information providing unit 13 to determine whether the driving involvement degree is equal to or higher than the termination determination threshold Th2. When determination is made that the driving involvement degree is equal to or higher than the termination determination threshold Th2 (S22: YES), the driver evaluation ECU 10 proceeds to S23. When determination is not made that the driving involvement degree is equal to or higher than the termination determination threshold Th2 (S22: NO), the driver evaluation ECU 10 proceeds to S24.

In S23, the driver evaluation ECU 10 causes the information providing unit 13 to provide the driver with information associated with the service level “hands-on soon”. The information providing unit 13 causes the display unit 6 to provide the information on the service level “hands-on soon” related to the driving involvement degree.

In S24, the driver evaluation ECU 10 causes the information providing unit 13 to provide the driver with information associated with the service level “hands-on request”. The information providing unit 13 causes the display unit 6 to provide the information on the service level “hands-on request” related to the driving involvement degree.

The driver evaluation information providing device 100 according to the present embodiment described above can provide information to the driver of the vehicle about the driving involvement degree of the driver evaluated by the device. Therefore, it is possible to reduce the occurrence of a case where the driver feels uncomfortable even if an alert is output to the driver or the autonomous driving or the driving assist is terminated based on the driving involvement degree.

The driver evaluation information providing device 100 provides information to the driver to indicate that the driving involvement degree is approaching the termination determination threshold. Therefore, it is possible to reduce the occurrence of a case where the driver feels uncomfortable about the termination of the traveling control as the autonomous driving or the driving assist due to a decrease in the driving involvement degree of the driver evaluated by the device. Similarly, the driver evaluation information providing device 100 provides information to the driver to indicate that the driving involvement degree evaluated by the device is changing away from the termination determination threshold. Therefore, motivation to increase the driving involvement degree can be given to the driver who desires to continue the traveling control as the autonomous driving or the driving assist.

While the traveling control is being performed, the driver evaluation information providing device 100 causes the display unit 6 to provide information to the driver continuously in real time. Therefore, the driver can check the driving involvement degree evaluated by the device at any timing during the autonomous driving or the driving assist. The driver evaluation information providing device 100 highlights the end of the bar-shaped lit portion of the display unit 6 that changes in length depending on a change in the driving involvement degree. Therefore, the driver can easily notice the change in the driving involvement degree. Further, the driver evaluation information providing device 100 varies the highlight of the end of the lit portion that decreases in length and the highlight of the end of the lit portion that increases in length. Therefore, the driver can easily know whether the driving involvement degree is decreasing or increasing.

Although the embodiment of the present disclosure has been described above, the present disclosure is not limited to the embodiment described above. The present disclosure may be carried out in various forms having various changes and improvements, including the embodiment described above.

The driver evaluation information providing device 100 only needs to include at least the driver monitor camera 1 as a device for monitoring the driver, and the external sensor 2, the steering sensor 3, the accelerator pedal sensor 4, and the brake pedal sensor 5 are not essential. Similarly, the driver evaluation information providing device 100 only needs to include at least the display unit 6 as an information providing device, and the speaker 7 and the vibration unit 8 are not essential.

The driver monitoring unit 11 need not necessarily determine whether the driver is in either of the look-away state, the distracted state, the unconcentrated state, etc. The driving involvement degree evaluation unit 12 may directly evaluate the driving involvement degree based on monitoring results from the driver monitoring unit 11 about the orientation of the driver's face, the condition of the eyelids, etc.

The driver monitoring unit 11 may acquire the driver's brain waves, heart rate, blood pressure, and other biometric information from a wearable device worn by the driver. The driving involvement degree evaluation unit 12 may evaluate the driving involvement degree based on the driver's biometric information.

The driver evaluation ECU 10 may provide information to the driver by communicating with the driver's wearable device. Examples of the wearable device include a smart watch (including a wristband device with no watch function) and smart glasses. The driver evaluation ECU 10 may provide information to the driver by vibration, audio output, or light blinking in the smart watch, or by audio output or image projection to the driver's sight in the smart glasses.

What is claimed is:

1. A driver evaluation information providing device comprising:
a driver monitoring unit configured to monitor a condition of a driver of a vehicle based on an image of the driver captured by a driver monitor camera of the vehicle;
a driving involvement degree evaluation unit configured to evaluate a driving involvement degree of the driver based on a result of monitoring of the condition of the driver by the driver monitoring unit; and
an information providing unit configured to provide, to the driver, information about the driving involvement degree evaluated by the driving involvement degree evaluation unit.

2. The driver evaluation information providing device according to claim 1, wherein:
the information providing unit is configured to, when the vehicle is performing traveling control as autonomous driving or driving assist, provide information indicating that the driving involvement degree is approaching a termination determination threshold to the driver; and
when the driving involvement degree is lower than the termination determination threshold, the traveling control is terminated.

3. The driver evaluation information providing device according to claim 2, wherein the information providing unit is configured to, when the vehicle is performing the traveling control, provide information indicating that the driving involvement degree is changing away from the termination determination threshold to the driver.

4. The driver evaluation information providing device according to claim 3, wherein the information providing unit is configured to continuously provide, by changing a length of a bar-shaped lit portion of a display unit provided in front of a driver's seat of the vehicle, information about the driving involvement degree to the driver while the traveling control is being performed.

5. The driver evaluation information providing device according to claim 4, wherein:
the information providing unit is configured to highlight an end of the bar-shaped lit portion of the display unit;
the end is configured to change, based on a change in the driving involvement degree, in length;
the information providing unit is configured to vary a first highlight and a second highlight;
the first highlight is a highlight of the end when the bar-shaped lit portion is configured to decrease in length due to a decrease in the driving involvement degree; and
the second highlight is a highlight of the end when the bar-shaped lit portion is configured to increase in length due to an increase in the driving involvement degree.

6. An evaluation information providing method for a driver evaluation information providing device configured to provide information to a driver of a vehicle, the evaluation information providing method comprising:
monitoring, by the driver evaluation information providing device, a condition of the driver based on an image of the driver captured by a driver monitor camera of the vehicle;
evaluating, by the driver evaluation information providing device, a driving involvement degree of the driver based on a result of monitoring of the condition of the driver; and
providing, by the driver evaluation information providing device, information about the driving involvement degree to the driver.

7. A driver evaluation information providing device comprising an electric control unit configured to
monitor a condition of a driver of a vehicle based on an image of the driver captured by a driver monitor camera of the vehicle;
evaluate a driving involvement degree of the driver based on a result of monitoring of the condition of the driver; and
provide, to the driver, information about the driving involvement degree.
